(19) United States
(12) Patent Application Publication
(10) Pub. No.: US 2019/0069478 A1
(43) Pub. Date: Mar. 7, 2019

(54) Mower with Improved Distribution of Cut Material

(71) Applicant: Heath Holmes, Tuscumbia, AL (US)

(72) Inventor: Heath Holmes, Tuscumbia, AL (US)

(21) Appl. No.: 16/120,601

(22) Filed: Sep. 4, 2018

Related U.S. Application Data
(60) Provisional application No. 62/554,020, filed on Sep. 5, 2017.

(51) Int. Cl. A01D 34/71; A01D 34/00; A01D 34/81

(52) U.S. Cl. CPC A01D 34/71; A01D 34/81; A01D 34/005

(57) ABSTRACT

An undercarriage of a rotary mower deck has a cutting chamber and encloses at least two cutting blades attached to a spindle. A flange encloses lateral sides of the cutting chamber to prevent discharge of debris laterally. A debris guide positioned toward a front end of the cutting chamber has the effect of reducing or eliminating formation of wind rows.

### BACKGROUND OF THE INVENTION

### Field of the Invention

The present invention relates to brush and grass cutting mowers that use rotating blades to cut and chop vegetation such as brush or grass. The invention provides for a mower that ejects cut debris (e.g. mulch) from the back and produces a more even distribution of discharged cut material than existing mowers. The invention also provides improvements to existing rearward ejecting mowers resulting in a more even distribution of discharged cuttings. Brush and grass cutting mowers are not to be confused with harvesters designed to preserve lengths of cut material, such as hay harvesting machines.

### BRIEF SUMMARY OF THE INVENTION

The present invention solves the problem of cutting debris forming wind rows, or linear piles of cutting debris, behind the deck of a mower as it moves forward while mowing. A debris guide prevents cutting debris from accumulating at a gap between a cutting blade and a wall, or side band, of the mowing deck. The guide causes the debris to accumulate at a location in the path of the mower blades as the mower moves forward. The invention is described using the example of a single spindle brush hog or “bush hog” type of rotary mower that is attached to the back of a farm tractor but is not limited to this type of mower and the invention is also applicable to brush mowers and finishing mowers having single or multiple spindles and riding or push mowers that do not discharge cutting debris laterally away from the mower or into a bag or other brush collecting means.

### BRIEF DESCRIPTION OF THE DRAWINGS

The elements of the drawings are not necessarily to scale relative to each other, with emphasis placed instead upon clearly illustrating the principles of the disclosure. Like reference numerals designate corresponding parts throughout the several views of the drawings in which:

FIG. 1 is a bottom view of a first embodiment of single spindle mowing deck comprising debris guides;

FIG. 2 is a front view of first embodiment of a single spindle mowing deck comprising debris guides;

FIG. 3 is a bottom view of an embodiment of a single spindle mowing deck comprising a flange or skirt shaped to form debris guides; and

FIG. 4 is a bottom view of an embodiment of a double spindle mowing deck comprising a flange or skirt shaped to form debris guides; and.

FIG. 5 is a bottom view of an embodiment of single spindle mowing deck comprising debris guides having an open leading edge and an open trailing edge.

### DETAILED DESCRIPTION OF THE INVENTION

All art specific terms used herein are intended to have their art-accepted meanings in the context of the description unless otherwise indicated. All non art specific terms are intended to have their plain language meaning in the context of the description unless otherwise indicated.

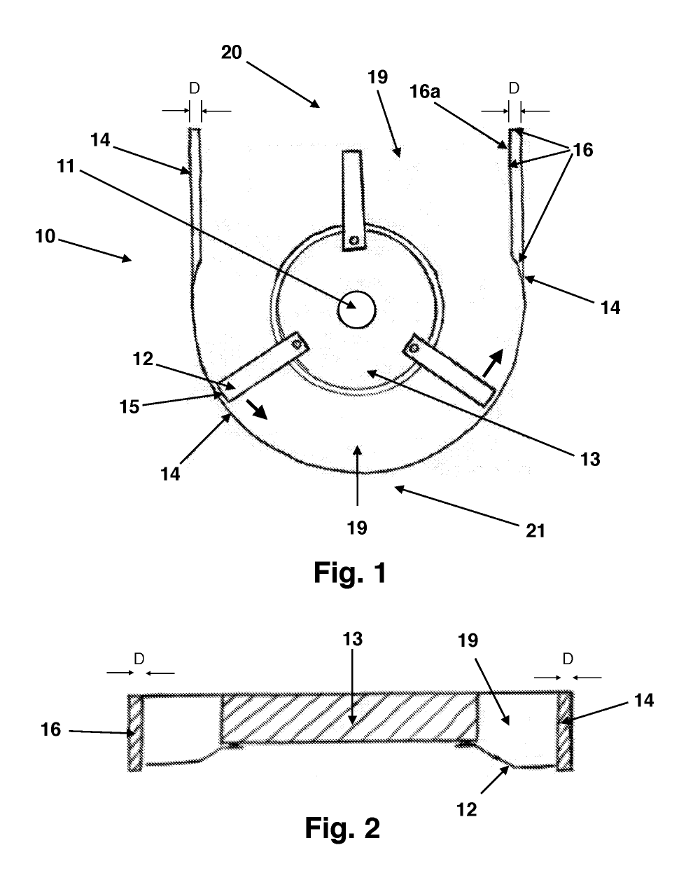

FIG. 1 shows the bottom view of an undercarriage of a brush mower (10) comprising three metal blades (12) that are attached to a spindle (11) via a blade carrier or blade pan (13) in a hinged manner that prevents the blades (12) from transferring the force of impacts by objects, such as rocks or stumps, to the spindle (11). As a consequence, a blade striking an object bounces backward and inward rather than bending or otherwise damaging the spindle (11). The blade (12) displaced in such a way automatically returns to a cutting position as a result of centrifugal force. A cutting chamber (19) is bounded on all sides except the front side (20) by a metal flange or skirt comprising sidebands (14). FIG. 5 shows an embodiment having a cutting chamber (19) that is bounded on all sides except the front side and a trailing side. The sidebands (14), usually made of steel, are continuous without openings that allow discharge of debris laterally from the mower. The sidebands (14) may join at the back side of the undercarriage and form the curve of the back (21) of the flange or skirt. The sidebands (14) may form another shape other than a curve behind the blades, such as a square or rectangle.

As shown in FIG. 5, embodiments of the invention may have an open trailing end rather than a closed back (21). A gap (15) between the ends of the blades (12) and the sidebands (14) must be sufficient to prevent the blades from striking the flange or skirt during use. The length L of the gap (15) is normally around 2 cm to 6 cm and may vary from mower to mower. As can be seen in the figures, the gap length L is the minimum gap length between the ends of the blades when spinning and the flange. This minimum gap length is normally at the lateral sides of the undercarriage.

The front (20) of the cutting chamber (19) is open to receive brush and grass as the mower is moved forward. The back (21) of the mower undercarriage may be open or may comprise an opening or cutout in the sideband (14) to allow the ejection of cutting debris backward from the cutting chamber (19). Such an opening is, however, not necessary because the space below the flange is normally far enough from the ground during use to allow the mower to pass over debris that falls from the cutting chamber (19).

The embodiment shown in FIG. 1 shows three blades (12) attached to a disc shaped blade pan (13) but the principle of the invention applies to mowers having two, four, or more blades as well as mowers comprising blade bars or blade pans (13) having other shapes. The blades need not be attached in a hinged manner for embodiments that are used on grounds that are free of obstructions that might cause damage to the spindle (11). The embodiment shown in FIG. 2, for example, has two blades (12) that are angled downward and outward from the blade pan. The principles of the invention apply to finishing mowers as well as brush mowers. The blades (12) need not be attached in a hinged manner and may be configured as conventional blades for finishing mowers used in normal grass cutting.

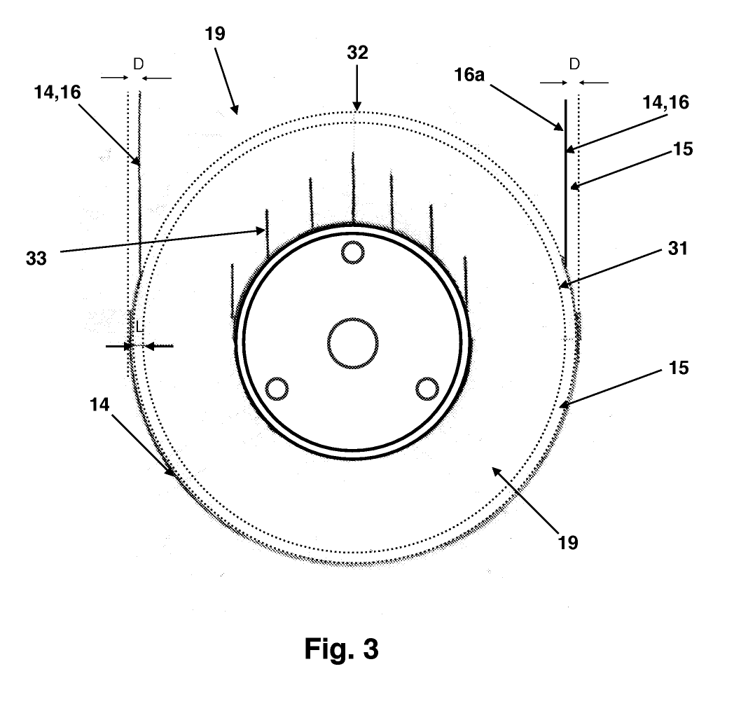

Rotation of the blades (12), the direction of which is indicated by arrows, causes a portion of the cutting debris to be cast along the sideband (14) ahead of the blades (12) in the direction of travel. A portion of the debris accumulated along the parallel sidebands (14) is normally not picked up by the blades (12) because of the gap (15) between the blades (12) and the sidebands (14). This results in a wind row, or linear pile of cutting debris, along either side of the mower. To prevent the formation of the windrows, one or more debris guides (16) are positioned toward the front end (20) of the cutting chamber (19) forward of the spindle (11) so that an inner facing surface (16a) of the debris guide (16) is positioned at a distance (D) from the sidebands (14) and extends downward from the deck (19) approximately the same distance as the sidebands (14). The debris guide(s) (16) reduce or prevent the accumulation of cutting debris on uncut brush and grass ahead of the blades (12) in the gap (15) between the ends of blades (12) and the sidebands (14). This gap (15) is also visible in FIG. 3 as the gap between circle (31) defined by the ends of rotating blades (12) in use and circle (32) defined by a curvature of the sidebands at a distance L from circle (31).

The distance (D) from the inner surface (16a) of the debris guide (16) to the sideband is approximately the length (L) of the gap (15) between the ends of blades (12) and the sidebands (14) or more. In preferred embodiments, the distance (D) from the inner surface (16a) of the debris guide (16) to the sideband is up to double the length (L) of the gap (15) between the blades (12) and the sidebands (14). For example, if the length (L) of the gap (15) is 2.5 cm, the distance (D) is preferably 2.5 to 5 cm. The inventor has found that this configuration is adequate to provide for the elimination of windrow formation during normal operation.

With reference to FIG. 2, an effect of positioning debris guides (16) on opposite lateral sides of the mower is to reduce the width of the intake at the front (20) of the mower by 2D. Two debris guides (16) are shown in this embodiment that reduce the lateral width of the open front (20) to the cutting chamber (19) to less than the diameter of the cutting circle (31) (FIG. 3) defined by the ends of the rotating blades (12) in use. In alternative embodiments, a single debris guide (16) may be positioned on either side of the mower (10) so that the open front (20) to the cutting chamber (19) is laterally offset from the center of the cutting chamber (19) and the width of the cutting chamber (19) is as wide as the circle (31) formed by the ends of the rotating blades (12). Additionally or alternatively, two debris guides may be positioned on opposite lateral sides with one being positioned more toward the front of the cutting chamber than the other.

In preferred embodiments, the debris guide(s) (16) are straight and positioned to be parallel to the sides of the mower deck intake and perpendicular to the flat front (20) of the mower (10) so that distance (D) is constant along the length of the debris guide (16). In alternative embodiments, the debris guide(s) (16) may be angled so that the distance (D) is not constant and, in such embodiments, the maximum distance (D) should closer to the blades (12) and minimum distance (D) toward the front (20) of the mower (10) with the maximum (D) being at least the length (L) of the gap (15) between the blades (12) and the sidebands (14), and preferably 1.2 to 2 times the length (L). A debris guide may thus have a rectangular block or the general shape of a wedge, or a block or edge with a curved back surface, the curvature preferably being that of the circle (32) defined by the curvature of the sidebands at a distance L from circle (31) defined by the ends of the rotating blades (12).

The debris guide(s) (16) is preferably positioned and dimensioned such that the front end of the guide (16) is essentially even with the front (20) of the mower deck (19) and such that the back end of the guide (16) ends at distance from the outer edge of circle (31) of blade rotation (FIG. 3) that is essentially the length (L) of the gap (15) between the blades (12) and the sidebands (14). The back end of the debris guide (16) may be positioned further from the blades but, as this distance becomes greater, more debris may fall in the path of the gap (15). The back end of the debris guide (16) is preferably shaped so as to continue the curvature (32) of the sideband (14) to a point at distance (D) from the widest part of the flange or skirt to prevent debris from collecting in a gap between the sideband (14) and the debris guide (16). The embodiment shown in FIG. 3 comprises optional ribs (33) in front of the blade pan (13) that form wedges pointed toward the front (20) of the cutting chamber that cause the blade pan (13) to ride over obstructions such as stumps or rocks.

Debris guides (16) may be installed on an existing mower (10) lacking such guides. FIGS. 1 and 2 show embodiments in which debris guides (16) are positioned on both sides of the mower. A kit for modifying a mower to include a debris guide (16) comprises a debris guide (16) and means for mounting the debris guide to the sideband (14) and/or the deck (19) of the mower. The mounting means may comprise welding, adhesives, magnets, bolts, screws, clamps, or combinations of these. For example, the debris guide (16) may be a ribbon of steel or aluminum bent to a shape as shown in FIG. 1 (16) or it may be solid. The debris guide may comprise two or more holes with the kit comprising two or more bolts long enough to span a distance from the inner surface (16a) to an outer surface of sideband (14). In another embodiment, the debris guide may be made of, or comprise, a magnetic metal and held to a steel sideband by magnetic force. The debris guide (16) may be made of a material suitable for exposure to the elements and mowing conditions such as wood, durable plastic, metal, composite materials, or combinations of these. In preferred embodiments, the debris guide (16) is made of steel or aluminum. The debris guide (16) may be a solid piece shaped to fill the space between the sideband (14) and the inner surface (16a) of the guide as shown in FIG. 2. The debris guide (16) may have a flat ribbon shape and may be curved, bent, or angled, for example as shown in FIG. 1, to leave a gap between the sideband (14) and the debris guide (16). The debris guide (16) may be of a single, unitary construction or it may comprise two or more pieces that are joined by welding or other joining means such as adhesives, bolts, screws, clamps, or combinations of these.

A mower may be constructed to incorporate debris guides (16) into the structure of sidebands (14) of a flange or skirt of the undercarriage of a mower (10). FIG. 3 is a bottom view of an undercarriage of a brush mower in which the sidebands (14) of the flange are arranged to form debris guides (16). The sidebands (14) do not extend tangentially from the curvature of a circle (32) having a radius of the outer edge of the blades (31) plus the gap (15). Instead, the sidebands follow the curvature of circle (32) for a lateral distance (D) and then extend forward so that the inner surfaces of the sidebands (14) form the inner surfaces (16a) of the debris guides (16).

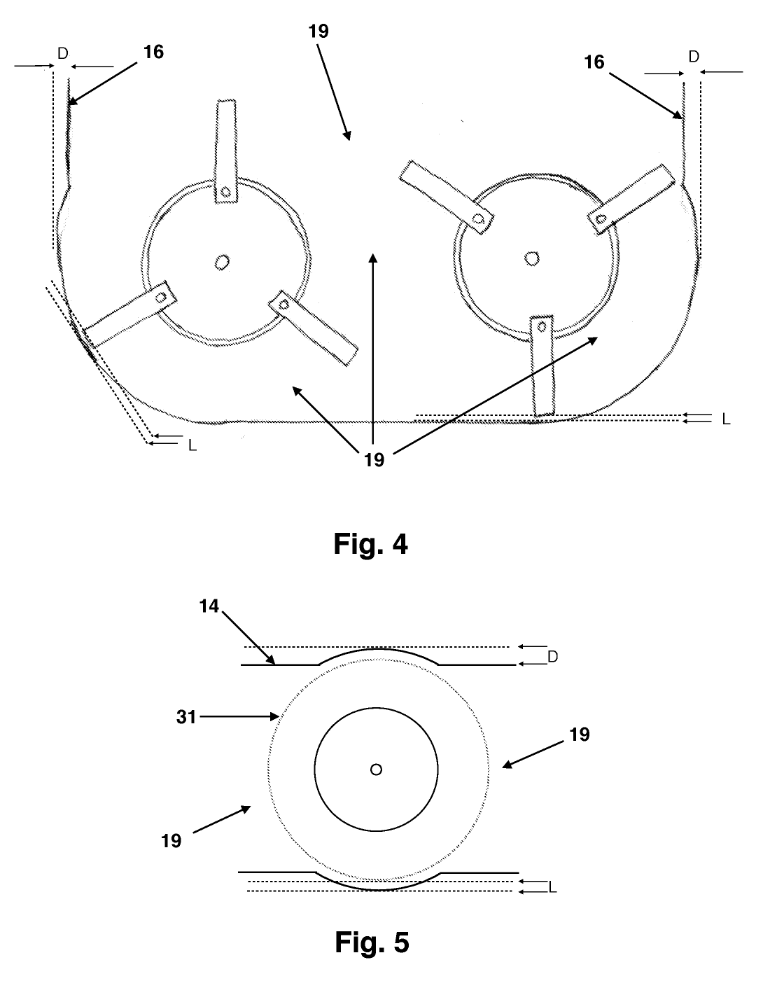

FIG. 4 is a bottom view of an embodiment of a two spindle mower (10) comprising two debris guides (16) that are integral with the sidebands (14), for example by bending the sideband material into a shape that forms the debris guides (16). The length (L) of the gap (15) between the blades (12) and the sidebands (14) is shown.

FIG. 5 is a bottom view of an embodiment of a mowing deck in which the front and back sides are open. The mowing deck may be, but need not be, of a substantially symmetrical design as shown in FIG. 5.

1. An undercarriage of a rotary mower deck comprising a cutting chamber, said undercarriage configured to enclose at least two cutting blades attached to a spindle, wherein:
the flange encloses lateral sides of the cutting chamber to prevent discharge of debris laterally from the cutting chamber;
the undercarriage comprises a debris guide;
a gap between the ends of the blades and the flange has a length L;
the debris guide is positioned toward a front end of the cutting chamber and forward of the spindle so that an inner facing surface of the debris guide is positioned at a distance D inward from the flange; and
the distance D from the inner surface of the debris guide to the flange is at least about the length L of the gap between the ends of the blades and the flange.

2. The undercarriage of claim 1, comprising two debris guides positioned opposite one another toward the front end of the cutting chamber.

3. The undercarriage of claim 2, wherein one of the two debris guides is positioned closer to a leading edge of the mowing deck than the other.

4. The undercarriage of claim 1, wherein the distance D from the inner surface of the debris guide to the flange is no more than double the length L of the gap between the blades and the flange.

5. The undercarriage of claim 1, wherein the debris guide is formed by a portion of the flange.

6. The undercarriage of claim 1, wherein the debris guide extends downward from the deck approximately the same distance as the flange or has a height dimension equal to the flange.

7. The undercarriage of claim 1, wherein the debris guide is not formed by a portion of the flange and is a separate piece mounted to the flange.

8. The undercarriage of claim 1, wherein the cutting chamber is bounded on the back by said flange.

9. The undercarriage of claim 6, wherein the flange bounding the back side comprises an opening configured to allow cutting debris to exit the cutting chamber.

10. The undercarriage of claim 1, wherein said undercarriage is configured to enclose more than one spindle.

11. A rotary mower comprising the undercarriage of claim 1.

12. A kit for mounting a debris guide to a flange of a rotary mower comprising an undercarriage containing a cutting chamber, said undercarriage comprising at least two cutting blades attached to a spindle and a flange, and a gap between the ends of the blades and the flange has a length L, said kit comprising:
a debris guide and means for mounting the debris guide to the flange,
wherein:
the debris guide is dimensioned to be positioned toward a front end of the cutting chamber forward of the spindle so that an inner facing surface of the debris guide is positioned at a distance D from the flange and extends downward from the deck approximately the same distance as the flange;
the distance D from the inner surface of the debris guide to the flange is at least the length L of the gap between the ends of the blades and the flange; and
said means for mounting the debris guide to the flange comprises one or more of a pair of magnets, a pair of bolts, a pair of clamps, and adhesive.
